(19) United States
(12) Patent Application Publication
(10) Pub. No.: US 2024/0056523 A1
(43) Pub. Date: Feb. 15, 2024

(54) METHOD FOR GENERATING A USER SCENARIO OF AN ELECTRONIC DEVICE

(71) Applicant: MEDIATEK INC., Hsin-Chu (TW)

(72) Inventors: Chin-Wei Hsu, Hsinchu City (TW); Po-Yu Chen, Hsinchu City (TW); Po-Chung Hsiao, Hsinchu City (TW); Yen-Liang Chen, Hsinchu City (TW)

(73) Assignee: MEDIATEK INC., Hsin-chu (TW)

(21) Appl. No.: 18/221,413

(22) Filed: Jul. 13, 2023

Related U.S. Application Data
(60) Provisional application No. 63/370,805, filed on Aug. 9, 2022.

(51) Int. Cl. H04M 1/72454; H01Q 1/24; G06F 1/16

(52) U.S. Cl. CPC H04M 1/72454; H01Q 1/243; G06F 1/1694

(57) ABSTRACT

A method for generating a user scenario of an electronic device includes detecting a real part and an imaginary part of an input impedance of each antenna of the electronic device, using a plurality of sensors of the electronic device to generate a plurality of sensing signals, and entering at least the real part and the imaginary part of the input impedance of each antenna, and the plurality of sensing signals to a machine learning model to output the user scenario.

### CROSS REFERENCE TO RELATED APPLICATIONS

This application claims the benefit of U.S. Provisional Application No. 63/370,805, filed on Aug. 9, 2022. The content of the application is incorporated herein by reference.

### BACKGROUND

A mobile device may include Bluetooth, Wi-Fi, sub-6 GHz, mmWave or another kind of antennas. When the mobile device is held by a hand or is held next to the head, an antenna in the mobile device may be blocked. The performance of the blocked antenna decreases as the impedance becomes mismatched and the radiation is blocked. Any antenna blockage impacts the performance of the antenna, and the cause of the blockage may be various hand grips of a user such as beside head hand right (BHHR), beside head hand left (BHHL), one hand only (right/left with landscape/portrait orientation), two hands (landscape/portrait orientation) and other inappropriate hand grips. The accurate antenna blockage detection can benefit the antenna related technology of the mobile device such as antenna selection, antenna tuning, power control, and other tuning applications by compensating the power loss caused by the blockage of antenna later on.

### SUMMARY

A method for generating a user scenario of an electronic device comprises detecting a real part and an imaginary part of an input impedance of each antenna of the electronic device, using a plurality of sensors of the electronic device to generate a plurality of sensing signals, and entering at least the real part and the imaginary part of the input impedance of each antenna, and the plurality of sensing signals to a machine learning model to output the user scenario.

A method for generating a detailed user scenario of an electronic device comprises detecting a real part and an imaginary part of an input impedance of each antenna of the electronic device, using a plurality of sensors of the electronic device to generate a plurality of sensing signals, determining a rough user scenario according to at least the plurality of sensing signals, and entering at least the real part and the imaginary part of the input impedance of each antenna to a machine learning model corresponding to the rough user scenario to output the detailed user scenario.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a mobile device according to an embodiment of the present invention.

FIG. 2 is a flowchart of a method for generating a user scenario of the mobile device in FIG. 1.

FIG. 3 shows another mobile device according to an embodiment of the present invention.

FIG. 4 is a flowchart of a method for generating a user scenario of the mobile device in FIG. 3.

FIG. 5 shows another mobile device according to an embodiment of the present invention.

FIG. 6 is a flowchart of a method for generating a user scenario of the mobile device in FIG. 5.

FIG. 7 shows another mobile device according to an embodiment of the present invention.

FIG. 8 is a flowchart of a method for generating a detailed user scenario of the mobile device in FIG. 7.

FIG. 9 illustrates a process of classifying a rough user scenario and a detailed user scenario of the mobile device in FIG. 7.

FIG. 10 is an example of classifying a rough user scenario and a detailed user scenario of the mobile device in FIG. 7.

FIG. 11 shows an example of a plurality of machine learning models of the mobile device in FIG. 7.

### DETAILED DESCRIPTION

In an embodiment of this invention, antennas impedance measurement can be utilized to detect the subtle change of antenna impedance. The embodiment integrates an application processor (AP), a sensor, and modem information with machine learning technique to recognize the antenna blockage scenarios of an electronic device. The modem information can include antenna impedance, signal to noise ratio (SNR), reference signal received power (RSRP), signal frequency, antenna tuner status and/or other features. The embodiment will reduce the complexity of the machine learning model and increase the accuracy of the scenario detection. The electronic device can be a mobile device.

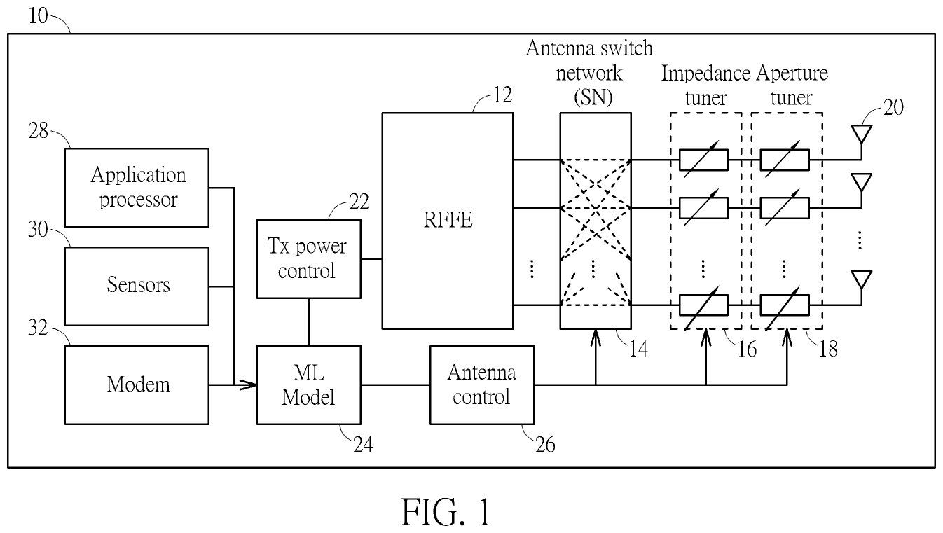

FIG. 1 shows a mobile device 10 according to an embodiment of the present invention. The mobile device 10 may comprise a radio frequency front end 12, an antenna switch network 14 coupled to the radio frequency front end (RFFE) 12, a plurality of impedance tuners 16 coupled to the antenna switch network 14, a plurality of aperture tuners 18 coupled to the plurality of impedance tuners 16, a plurality of antennas 20 coupled to the aperture tuners 18, a transmitter (Tx) power control 22 coupled to the radio frequency front end 12, a machine learning (ML) model 24 coupled to the transmitter power control 22, an application processor 28 coupled to the machine learning model 24, a plurality of sensors 30 coupled to the machine learning model 24, a modem 32 coupled to the machine learning model 24, and an antenna control 26 coupled to the machine learning model 24, the antenna switch network 14, the plurality of impedance tuners 16, the plurality of aperture tuners 18, the application processor 28, the plurality of sensors 30, and the modem 32. The machine learning model 24 may be a deep neural network (DNN), a support vector machine (SVM), convolutional neural network (CNN), decision tree, random forest, K-Nearest Neighbor (KNN), or Naive Bayes.

The antenna control 26 controls the antenna switch network 14 to selectively couple the radio frequency front end 12 to the plurality of antennas 20 according to output signals of the machine learning model 24. The antenna control 26 controls the aperture tuners 18 to coarse tune the impedances of the plurality of antennas 20 according to output signals of the machine learning model 24. The antenna control 26 controls the impedance tuners 16 to fine tune the impedances of the plurality of antennas 20 according to output signals of the machine learning model 24. The transmitter power control 22 controls the power of the radio frequency front end 12 according to output signals of the machine learning model 24 so as to supply appropriate power to the selected antennas of the plurality of antennas 20.

The application processor 28 provides universal serial bus (USB) connection status to the machine learning model 24. If the mobile device 10 is foldable, the application processor 28 may also provide fold status of the mobile device 10 to the machine learning model 24.

The plurality of sensors 30 may comprise a proximity sensor for sensing the distance between the mobile device 10 and an object such as the head or finger of a user, an orientation sensor for sensing if the mobile device 10 should be in the landscape or portrait mode, an accelerometer for measuring accelerations of the mobile device 10 in three spatial axes, and a gyroscope for measuring orientation and angular velocities of the mobile device 10. The plurality of sensors may output the data generated by the proximity sensor, the orientation sensor, the accelerometer, and/or the gyroscope to the machine learning model 24.

The modem 32 may calculate the signal to noise ratio (SNR), reference signal received power (RSRP), voltage standing wave ratio (VSWR), and/or real part and imaginary part of the antenna impedances. And the modem 32 may output the signal to noise ratio, reference signal received power, voltage standing wave ratio, and/or real part and imaginary part of the antenna impedances to the machine learning model 24.

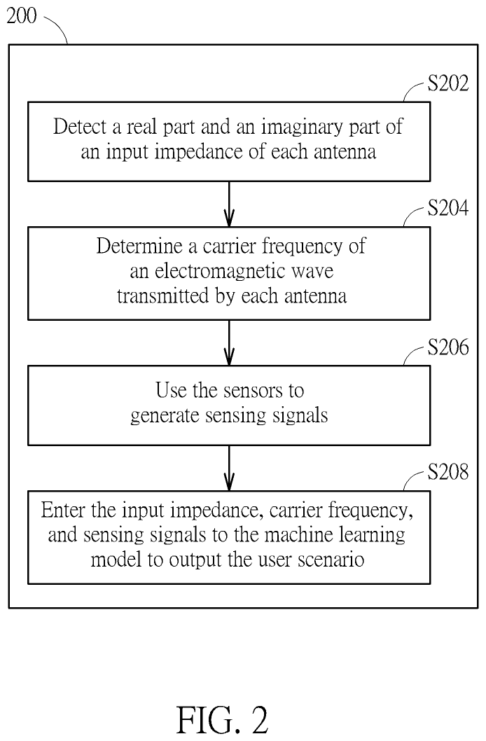

FIG. 2 is a flowchart of a method 200 for generating a user scenario of the mobile device 10. The method 200 comprises the following steps:
Step S202: detect a real part and an imaginary part of an input impedance of each antenna 20 of the mobile device 10;
Step S204: determine a carrier frequency of an electromagnetic wave transmitted by each antenna 20 of the mobile device 10;
Step S206: use the plurality of sensors 30 of the mobile device 10 to generate a plurality of sensing signals; and
Step S208: enter the real part and the imaginary part of the input impedance of each antenna 20, the carrier frequency of the electromagnetic wave transmitted by each antenna 20 of the mobile device 10, and the plurality of sensing signals to the machine learning model 24 to output the user scenario.

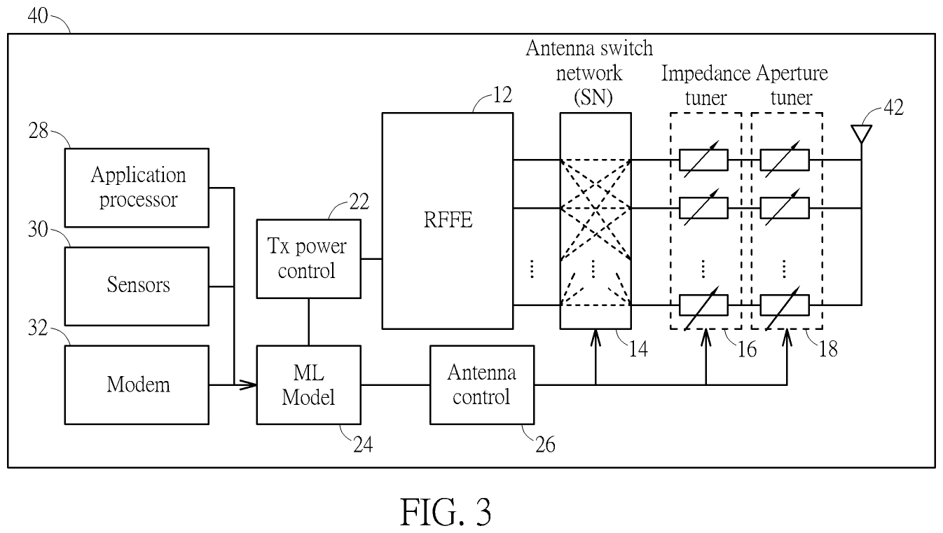

FIG. 3 shows another mobile device 40 according to an embodiment of the present invention. The difference between the mobile devices 10 and 40 is that the mobile device 40 only has one antenna 42. The antenna 42 is coupled to all of the plurality of aperture tuners 18.

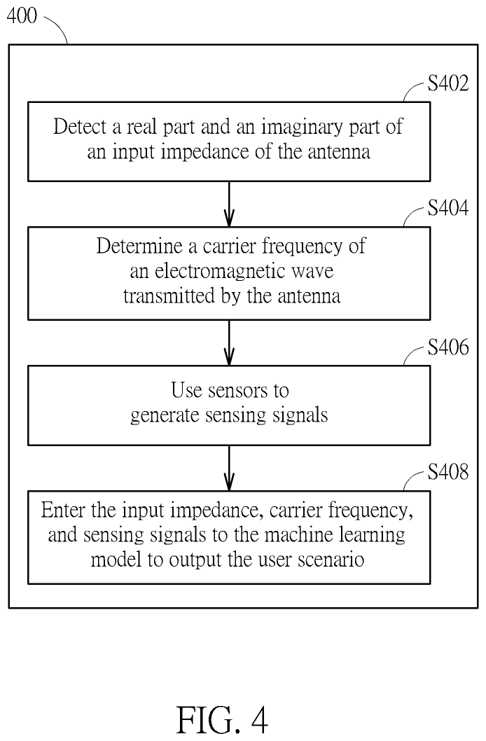

FIG. 4 is a flowchart of a method 400 for generating a user scenario of the mobile device 40. The method 400 comprises the following steps:
Step S402: detect a real part and an imaginary part of an input impedance of the antenna 42 of the mobile device 40;
Step S404: determine a carrier frequency of an electromagnetic wave transmitted by the antenna 42 of the mobile device 40;
Step S406: use the plurality of sensors 30 of the mobile device 40 to generate a plurality of sensing signals; and
Step S408: enter the real part and the imaginary part of the input impedance of the antenna 42, the carrier frequency of the electromagnetic wave transmitted by the antenna 42 of the mobile device 40, and the plurality of sensing signals to the machine learning model 24 to output the user scenario.

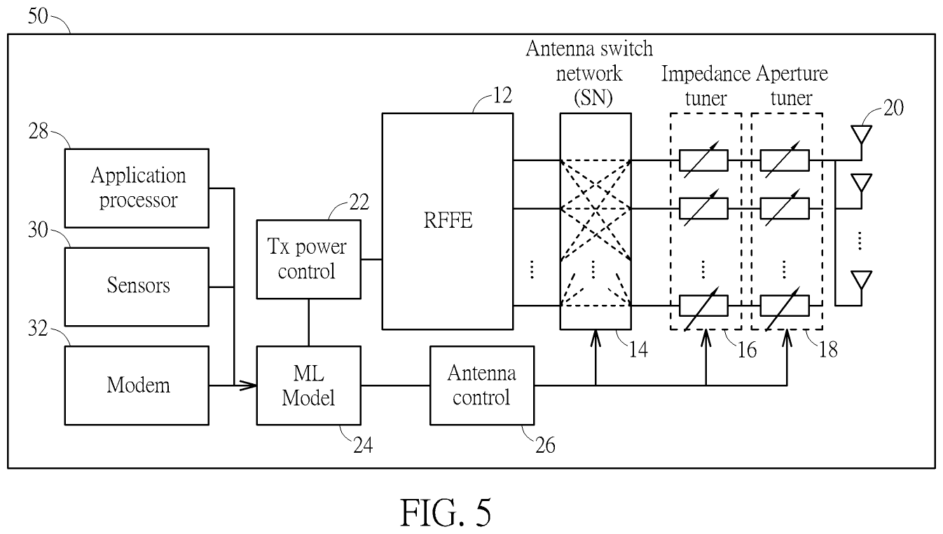

FIG. 5 shows another mobile device 50 according to an embodiment of the present invention. The difference between the mobile devices 10 and 50 is that the plurality of antennas 52 of the mobile device 50 are coupled to only one of the aperture tuners 18.

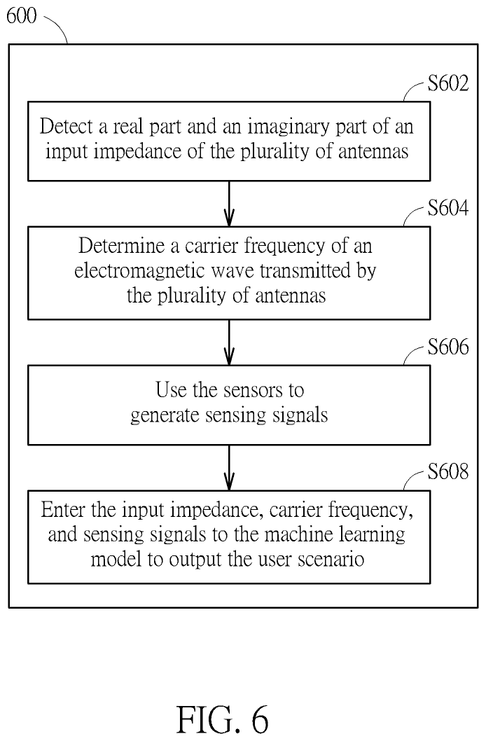

FIG. 6 is a flowchart of a method 600 for generating a user scenario of the mobile device 50. The method 600 comprises the following steps:
Step S602: detect a real part and an imaginary part of an input impedance of the plurality of antennas 52 of the mobile device 50;
Step S604: determine a carrier frequency of electromagnetic waves transmitted by the plurality of antennas 52 of the mobile device 50;
Step S606: use the plurality of sensors 30 of the mobile device 50 to generate a plurality of sensing signals; and
Step S608: enter the real part and the imaginary part of the input impedance of the plurality of antennas 52, the carrier frequency of the electromagnetic waves transmitted by the plurality of antennas 52 of the mobile device 50, and the plurality of sensing signals to the machine learning model 24 to output the user scenario.
Steps S204, S404, S604 are optional. If Steps S204, S404, S604 are omitted, the carrier frequency of the electromagnetic waves transmitted by the plurality of antennas 20, 42, 52 of the mobile device 10, 40, 50 would not be entered to the machine learning model 24 in Steps S208, S408, S608. In Steps S208, S408, S608, outputs of the application processor 28 may also be inputted to the machine learning model 24 for determining the user scenario. The user scenario may be beside head and hand left (BHHL), beside head and hand right (BHHR), landscape with one left hand hold, landscape with one right hand hold, landscape with two hands hold, portrait with one left hand hold, portrait with one right hand hold, or portrait with two hands hold.

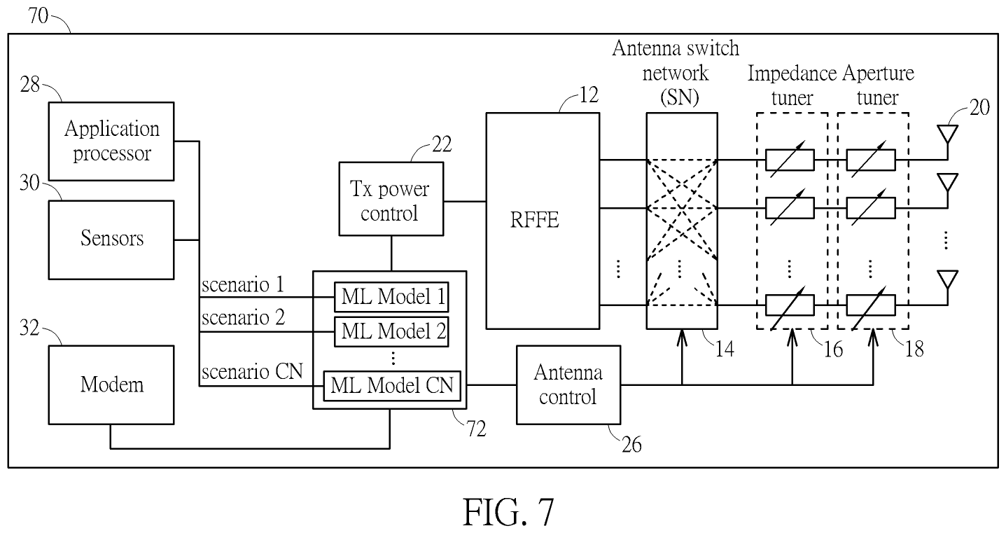

FIG. 7 shows another mobile device 70 according to an embodiment of the present invention. The difference between the mobile devices 10 and 70 is that the mobile device 70 comprises CN machine learning models 72 each corresponding to a rough user scenario where CN is an integer greater than 1. The rough user scenario is classified by outputs from the application processor 28 and the plurality of sensors 30. The modem 32 is coupled to the CN machine learning models for outputting the signal to noise ratio, reference signal received power, voltage standing wave ratio, and/or real part and imaginary part of the antenna impedances to the machine learning model 72 corresponding to the rough user scenario.

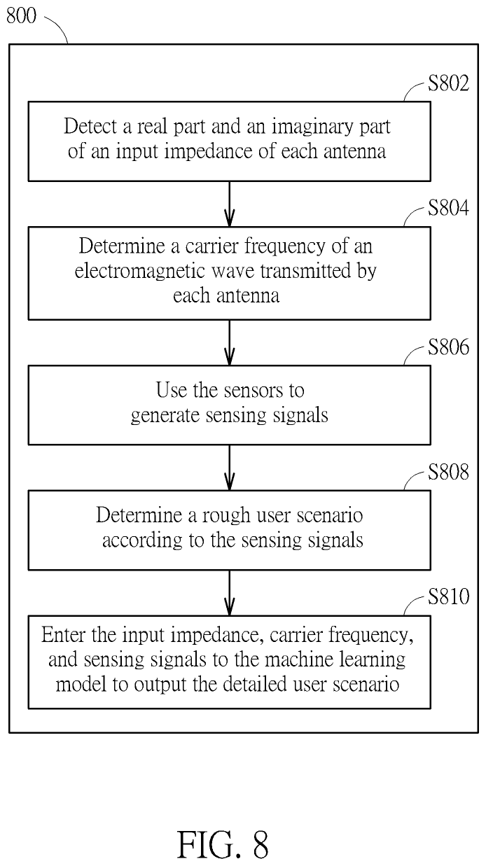

FIG. 8 is a flowchart of a method 800 for generating a detailed user scenario of the mobile device 70. The method 800 comprises the following steps:
Step S802: detect a real part and an imaginary part of an input impedance of each antenna 20 of the mobile device 70;
Step S804: determine a carrier frequency of an electromagnetic wave transmitted by each antenna 20 of the mobile device 70;
Step S806: use a plurality of sensors 30 of the mobile device 70 to generate a plurality of sensing signals;
Step S808: determine a rough user scenario according to the plurality of sensing signals; and
Step S810: enter the real part and the imaginary part of the input impedance of each antenna 20, and the carrier frequency of the electromagnetic wave transmitted by each antenna 20 of the mobile device 70 to the machine learning model 72 corresponding to the rough user scenario to output the detailed user scenario.
Step S804 is optional. If Step S804 is omitted, the carrier frequency of the electromagnetic wave transmitted by each antenna 20 of the mobile device 70 would not be entered to the machine learning model 72 in Step S810. In Step S808, outputs of the application processor 28 may also be used to determine the rough user scenario. The rough user scenario may be beside head, hand landscape, or hand portrait. The detailed user scenario may be beside head and hand left (BHHL), beside head and hand right (BHHR), landscape with one left hand hold, landscape with one right hand hold, landscape with two hands hold, portrait with one left hand hold, portrait with one right hand hold, or portrait with two hands hold. In Step S810, the connection status of the mobile device 70 with a universal serial bus (USB), and/or a fold status of the mobile device 70 can also be entered to the machine learning model 72 to output the detailed user scenario. Moreover, methods similar to the method 800 can be used to generate detailed user scenarios for mobile devices similar to the mobile device 70 except the antennas are coupled to the aperture tuners 18 in the manner of the mobile devices 40, 50.

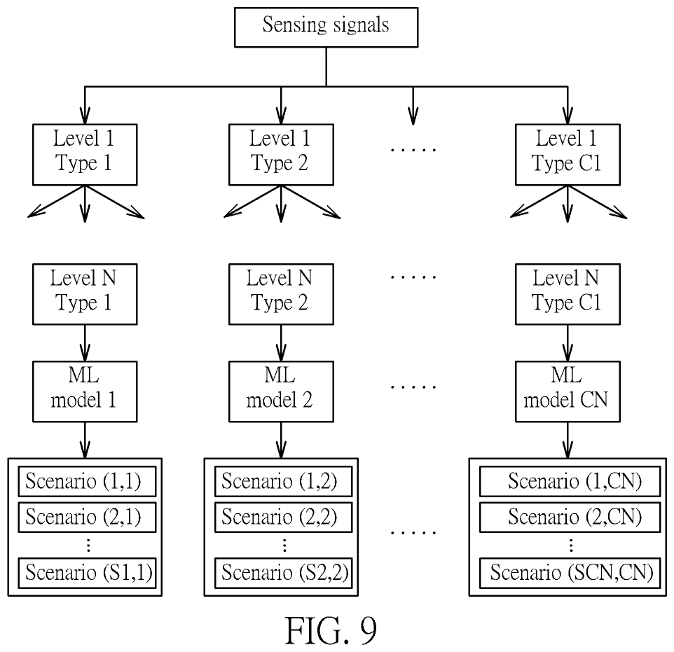

FIG. 9 illustrates the process of classifying a rough user scenario and a detailed user scenario of the mobile device 70. The classification of the rough user scenario can be performed in N levels. At the first level, the user scenario is roughly classified into one of C1 types according to a sensing signal. At the second level, another sensing signal is employed to roughly classify the user scenario into one of C2 types, and so on. At the Nth level, another sensing signal is employed to roughly classify the user scenario into one of CN types. Each of the CN types corresponds to a machine learning model 1 to CN. Once the user scenario is determined to be one of the CN types, the real part and the imaginary part of the input impedance of each antenna 20, and the carrier frequency of the electromagnetic wave transmitted by each antenna 20 of the mobile device 70 would be entered to the machine learning model corresponding to the determined rough user scenario to output the detailed user scenario. Each of the machine learning models 1 to CN has a plurality of corresponding detailed user scenarios (1,1) to (S1,1), (1,2) to (S2,2), . . . , (1,CN) to (SCN,CN). The detailed user scenario generated by the machine learning model 1 to CN would be one of the detailed user scenarios corresponding to the machine learning model 1 to CN.

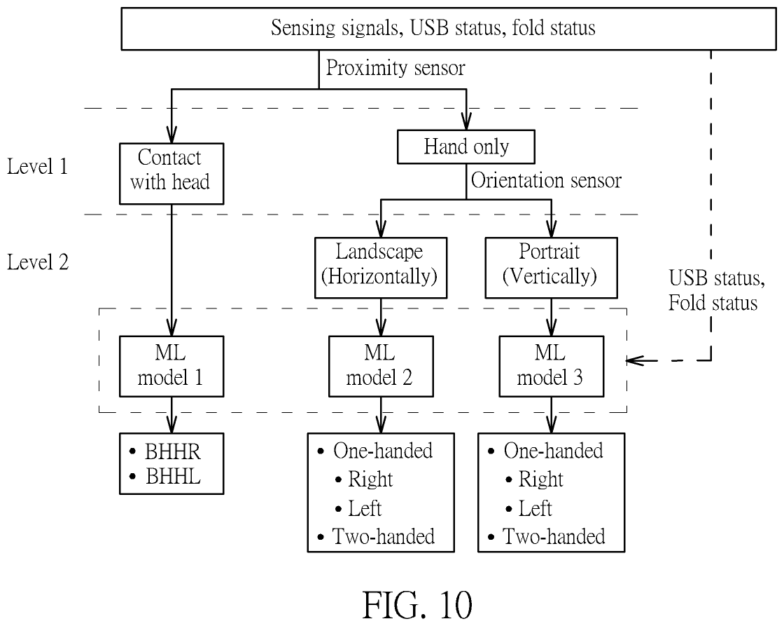

FIG. 10 is an example of classifying a rough user scenario and a detailed user scenario of the mobile device 70. A proximity sensor is used in level 1 to roughly classify the user scenario to be “contact with head” or “hand only”. If in level 1, the user scenario is roughly classified to be “contact with head”, then the real part and the imaginary part of the input impedance of each antenna 20, the carrier frequency of the electromagnetic wave transmitted by each antenna 20 of the mobile device 70, the connection status of the mobile device 70 with a universal serial bus (USB), and a fold status of the mobile device 70 would be entered to the machine learning model 1 to output the detailed user scenario. The detailed user scenarios corresponding to the machine learning model 1 are “beside head hand right (BHHR)”, “beside head hand left (BHHL)”, thus the detailed user scenario outputted by the machine learning model 1 would be “beside head hand right” or “beside head hand left”.

If in level 1, the user scenario is roughly classified to be “hand only”, an orientation sensor is used in level 2 to roughly classify the user scenario to be “landscape” or “portrait”. If in level 2, the user scenario is roughly classified to be “landscape”, then the real part and the imaginary part of the input impedance of each antenna 20, the carrier frequency of the electromagnetic wave transmitted by each antenna 20 of the mobile device 70, the connection status of the mobile device 70 with a universal serial bus (USB), and a fold status of the mobile device 70 would be entered to the machine learning model 2 to output the detailed user scenario. The detailed user scenarios corresponding to the machine learning model 2 are “landscape with one left hand hold”, “landscape with one right hand hold”, and “landscape with two hands hold”, thus the detailed user scenario outputted by the machine learning model 2 would be “landscape with one left hand hold”, “landscape with one right hand hold”, or “landscape with two hands hold”.

If in level 2, the user scenario is roughly classified to be “portrait”, then the real part and the imaginary part of the input impedance of each antenna 20, the carrier frequency of the electromagnetic wave transmitted by each antenna 20 of the mobile device 70, the connection status of the mobile device 70 with a universal serial bus (USB), and a fold status of the mobile device 70 would be entered to the machine learning model 3 to output the detailed user scenario. The detailed user scenarios corresponding to the machine learning model 3 are “portrait with one left hand hold”, “portrait with one right hand hold”, and “portrait with two hands hold”, thus the detailed user scenario outputted by the machine learning model 3 would be “portrait with one left hand hold”, “portrait with one right hand hold”, or “portrait with two hands hold”.

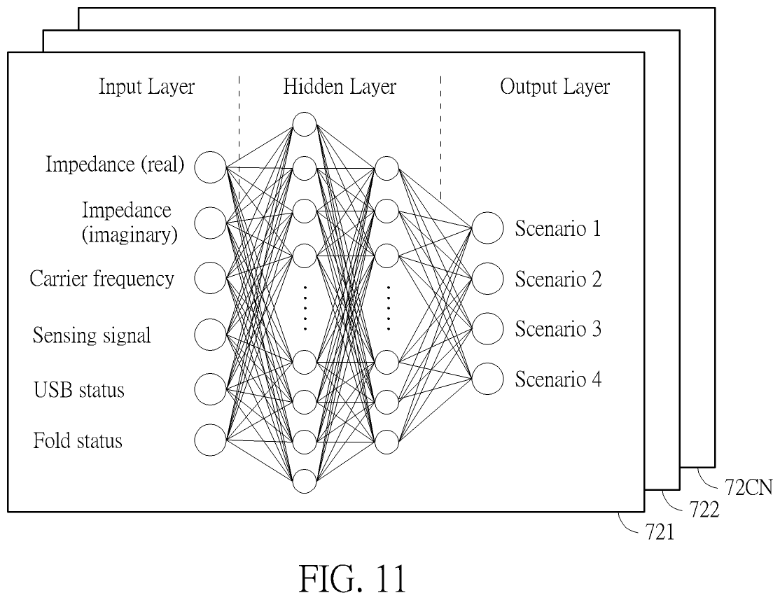

FIG. 11 shows an example of a plurality of machine learning models 721-72CN. The machine learning models 721-72CN may correspond to the plurality of machine learning models 72 in FIG. 7. The rough user scenario decides which machine learning model is to be selected for generating the detailed user scenario. Suppose the machine learning model 721 is selected, then the machine learning model 721 uses the antenna impedance, the carrier frequency, the plurality of sensing signals, the universal serial bus (USB) status, and/or the fold status of the mobile device as input features to output one of the four detailed user scenarios 1 to 4. Thus, comparing to the mobile device 10, the complexity of the machine learning models 72 of the mobile device 70 is reduced and the accuracy of outputting the correct user scenario is enhanced.

In this invention, the detailed user scenarios are classified by the machine learning models according to the rough user scenarios. The classified result can be used to improve radio frequency (RF) behavior through selecting antennas by the antenna switch network 14, tuning the impedances of the plurality of antennas 20 by the antenna control 26, and controlling the power of the radio frequency front end 12 by the transmitter power control 22. The proposed method can enhance the accuracy of outputting the correct user scenario and reduce the complexity of generating the user scenario due to the preliminary model split by the application processor 28 and the plurality of sensors 30.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating a user scenario of an electronic device, comprising:
detecting a real part and an imaginary part of an input impedance of each antenna of the electronic device;
using a plurality of sensors of the electronic device to generate a plurality of sensing signals; and
entering at least the real part and the imaginary part of the input impedance of each antenna, and the plurality of sensing signals to a machine learning model to output the user scenario.

2. The method of claim 1, wherein the plurality of sensors include a proximity sensor and/or an orientation sensor.

3. The method of claim 1, wherein the electronic device comprises an application processor for detecting a connection status of the electronic device with a universal serial bus (USB), and/or a fold status of the electronic device.

4. The method of claim 3, wherein the connection status and/or the fold status is also entered to the machine learning model to output the user scenario.

5. The method of claim 1 further comprising determining a carrier frequency of an electromagnetic wave transmitted by each antenna of the electronic device, wherein the carrier frequency of the electromagnetic wave transmitted by each antenna of the electronic device is also entered to the machine learning model to output the user scenario.

6. The method of claim 1, wherein the machine learning model is a deep neural network (DNN), a support vector machine (SVM), convolutional neural network (CNN), decision tree, random forest, K-Nearest Neighbor (KNN), or Naive Bayes.

7. The method of claim 1, wherein the user scenario is beside head and hand left (BHHL), beside head and hand right (BHHR), landscape with one left hand hold, landscape with one right hand hold, landscape with two hands hold, portrait with one left hand hold, portrait with one right hand hold, or portrait with two hands hold.

8. A method for generating a detailed user scenario of an electronic device, comprising:
detecting a real part and an imaginary part of an input impedance of each antenna of the electronic device;
using a plurality of sensors of the electronic device to generate a plurality of sensing signals;
determining a rough user scenario according to at least the plurality of sensing signals; and
entering at least the real part and the imaginary part of the input impedance of each antenna to a machine learning model corresponding to the rough user scenario to output the detailed user scenario.

9. The method of claim 8, wherein the plurality of sensors include a proximity sensor and/or an orientation sensor.

10. The method of claim 8, wherein the electronic device comprises an application processor for detecting a connection status of the electronic device with a universal serial bus (USB), and/or a fold status of the electronic device.

11. The method of claim 10, wherein the connection status and/or the fold status is also used to determine the rough user scenario.

12. The method of claim 10, wherein the connection status and/or the fold status is also entered to the machine learning model to output the detailed user scenario.

13. The method of claim 8 further comprising determining a carrier frequency of an electromagnetic wave transmitted by each antenna of the electronic device, wherein the carrier frequency of the electromagnetic wave transmitted by each antenna of the electronic device is also entered to the machine learning model to output the detailed user scenario.

14. The method of claim 8, wherein the machine learning model is a deep neural network (DNN), a support vector machine (SVM), convolutional neural network (CNN), decision tree, random forest, K-Nearest Neighbor (KNN), or Naive Bayes.

15. The method of claim 8, wherein the rough user scenario is a beside head scenario.

16. The method of claim 15, wherein the detailed user scenario is beside head and hand left (BHHL) or beside head and hand right (BHHR).

17. The method of claim 8, wherein the rough user scenario is a hand landscape scenario.

18. The method of claim 17, wherein the detailed user scenario is landscape with one left hand hold, landscape with one right hand hold, or landscape with two hands hold.

19. The method of claim 8, wherein the rough user scenario is a hand portrait scenario.

20. The method of claim 19, wherein the detailed user scenario is portrait with one left hand hold, portrait with one right hand hold, or portrait with two hands hold.
